(19) United States
(12) Patent Application Publication
(10) Pub. No.: US 2022/0122038 A1
(43) Pub. Date: Apr. 21, 2022

(54) Process Version Control for Business Process Management

(71) Applicant: Kyndryl, Inc., New York, NY (US)

(72) Inventors: Jun Duan, Mount Kisco, NY (US); Qi Ming Teng, Beijing (CN); Sai Zeng, Yorktown Heights, NY (US); Christopher Peter Baker, East Sussex (GB); Alexei Karve, Mohegan Lake, NY (US)

(73) Assignee: Kyndryl, Inc., New York, NY (US)

(21) Appl. No.: 17/074,699

(22) Filed: Oct. 20, 2020

(51) Int. Cl. G06Q 10/10; G06Q 10/04; G06Q 10/06; G06N 20/00; G06N 5/04; G06F 40/20

(52) U.S. Cl. CPC G06Q 10/103; G06Q 10/04; G06Q 10/0633; G06F 40/20; G06N 20/00; G06N 5/04; G06Q 10/06375

(57) ABSTRACT

An artificial intelligence (AI) platform to support workflow version process control. One or more workflows corresponding to one or more workflow engines are monitored. A neural network is employed to capture a relationship associated with a detected change in the monitored workflows. The neural network is leveraged to identify and assess an impact of the detected change to one or more additional workflows. Responsive to the assessment, the impacted workflow engines are optimized. The optimization includes automatically mapping and encoding changes corresponding to the impacted workflow. The one or more workflows containing the encoded changes are then executed.

### BACKGROUND

The present embodiments relate to workflow engines and collaboration between two or more heterogeneous workflow engines. More specifically, the embodiments relate to a platform functioning as a unified interface for managing workflow version control of two or more heterogeneous workflow engines.

Business process management (BPM) is a structured approach that models a business' tasks and the interactions between the tasks as processes. BPM software is a type of application that is aimed at streamlining business processes and workflows in order for them to become more efficient and adapt to ever-changing environments. BPM can be seen as an extension of workflow management that primarily focuses on the automation of business processes, whereas BPM has a broader scope ranging from process automation and process analysis to operations management and the organization of work.

A workflow is a series of repeatable tasks that are necessary to complete a goal to execute a business process, and is represented as a codified infrastructure of operations. The business process is a collection of interlinked steps that are performed by a group of users in order to accomplish a specific organizational goal. Each task in a workflow has a specific prior task and a specific subsequent task, with the exception of the initial workflow task. A workflow engine is a software platform to manage one or more corresponding and encoded workflows, e.g. to manage business processes. Different workflow engines may utilize different tools and different data sources. At the same time, different workflow engines may share some aspects, including but not limited to content and application program interfaces.

### SUMMARY

The embodiments include a system, computer program product, and method for managing workflow version control of two or more heterogeneous workflow engines.

In one aspect, a computer system is provided with a processing unit operatively coupled to memory, and an artificial intelligence (AI) platform operatively coupled to the processing unit. The AI platform supports workflow version control of two or more heterogeneous workflow engines. The AI platform includes tools in the form of a committer and a selector. The committer functions to monitor one or more workflows corresponding to one or more workflow engines. In an exemplary embodiment, the monitor of the one or more workflows includes the committer to leverage natural language processing (NLP) to detect the change, such changes including: an added or removed argument, modification of an existing argument, an application program interface (API), and combinations thereof. The selector, which is operatively coupled to the committer, employs a neural network to capture a relationship associated with a detected change in the monitored workflows. The selector identifies and assesses an impact of the detected change to one or more additional workflows. Responsive to the assessment, the selector selectively optimizes the workflow engines. The optimization includes automatically mapping and encoding changes corresponding to the impacted workflow. The processing unit executes the one or more workflows containing encoded changes.

In another aspect, a computer program product is provided to support workflow version control of two or more heterogeneous workflow engines. The computer program product includes a computer readable storage medium having program code embodied therewith. Program code, which is executable by a processor, is provided to monitor one or more workflows corresponding to one or more workflow engines. In an exemplary embodiment, the workflow monitoring includes leveraging natural language processing (NLP) to detect the change, such changes including: an added or removed argument, modification of an existing argument, an application program interface (API), and combinations thereof. The program code employs a neural network to capture a relationship associated with a detected change in the monitored workflows. The program code identifies and assesses an impact of the detected change to one or more additional workflows. Responsive to the assessment, the impacted workflow engines are optimized. The optimization includes automatically mapping and encoding changes corresponding to the impacted workflow. The program code executes the one or more workflows containing encoded changes.

In yet another aspect, a method is provided to support workflow version control of two or more heterogeneous workflow engines. The method includes monitoring one or more workflows corresponding to one or more workflow engines. In an exemplary embodiment, the workflow monitoring includes leveraging natural language processing (NLP) to detect the change, such changes including: an added or removed argument, modification of an existing argument, an application program interface (API), and combinations thereof. A neural network is employed to capture a relationship associated with a detected change in the monitored workflows. An impact of the detected change to one or more additional workflows is identified and assessed. Responsive to the assessment, the impacted workflow engines are optimized. The optimization includes automatically mapping and encoding changes corresponding to the impacted workflow. The one or more workflows containing encoded changes are then executed.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings reference herein forms a part of the specification. Features shown in the drawings are meant as illustrative of only some embodiments, and not of all embodiments, unless otherwise explicitly indicated.

FIG. 1 depicts a schematic diagram of a computer system to support and enable managing workflow version control of two or more heterogeneous workflow engines.

FIG. 2 depicts a flow chart illustrating a process for managing workflow version control.

FIG. 3 depicts a flow chart illustrating an example application of smart version control.

FIG. 4 depicts a block diagram illustrating an example of a computer system/server of a cloud based support system, to implement the system and processes described above with respect to FIGS. 1-3.

FIG. 5 depicts a block diagram illustrating a cloud computer environment.

FIG. 6 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following detailed description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.com

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

BPM solutions model business procedures as process definitions and instantiate the definition with content for execution. Each business process is composed by the workflow definition and content. A process definition may have multiple versions, and for various reasons. For example, a process may accept different sets of inputs and generate different sets of output, thereby resulting in multiple versions. An instantiated instance may last for a set period of time during which a corresponding business procedure may change. Each change of the process definition creates an additional version. Similarly, each fix of a design time omission creates an additional version.

The reason for the change to the process definitions may be persistent or transient. In the case of a transient change, it may be necessary to store one or more prior definitions in the event the process definition has to be restored. As shown and described herein, the versions of the process definitions are coherently arranged to provide flexibility and manageability thereof so that change of the content can automatically trigger creation of a new version of a corresponding business process. With respect to an automated version update or update process, it can become burdensome and time consuming to detect process definitions that would warrant a workflow change or differences between multiple versions of the same workflow. The automated version update allows for the propagation of changes to all business processes which are affected by the detected content change. Accordingly, as shown and described herein an artificial intelligence platform is provided to discover change scenarios for both input and output of the content, and to selectively modify an affected workflow engine.

A workflow engine is a software application or tool designed to enforce a series of recurring tasks that make up a workflow. As shown and described herein, a commit is a declarative representation of an instance of a business process. Each business process is composed by a workflow definition and contents, which in an embodiment may be scripts, comments, application process interface (API) calls, and nested workflow. Commits are organized and stored in a repository, e.g. knowledge base, and operatively coupled to an interface to enable cross-platform sharing and collaboration. Multiple commits may be stored for the same workflow or different workflows, with each commit representing a different version of the workflow. Workflow version control is a system and method for reconciling and deploying the stored commits to the appropriate workflow engines. The workflow version control includes the ability to revert a workflow documented or reflected in a previously instantiated commit. In an embodiment, workflow version control may also be referred to herein as process version control, or process version control of workflow.

Artificial Intelligence (AI) relates to the field of computer science directed at computers and computer behavior as related to humans. AI refers to the intelligence when machines, based on information, are able to make decisions, which maximizes the chance of success in a given topic. More specifically, AI is able to learn from a dataset to solve problems and provide relevant recommendations. For example, in the field of artificial intelligent computer systems, natural language systems (such as the IBM Watson® artificially intelligent computer system or other natural language interrogatory answering systems) process natural language based on system-acquired knowledge. To process natural language, the system may be trained with data derived from a database or corpus of knowledge, but the resulting outcome can be incorrect or inaccurate for a variety of reasons.

Machine learning (ML), which is a subset of Artificial Intelligence (AI), utilizes algorithms to learn from data and create foresights based on this data. Cognitive computing is a mixture of computer science and cognitive science. Cognitive computing utilizes self-teaching algorithms that use minimum data, visual recognition, and natural language processing to solve problems and optimize human processes.

At the core of AI and associated reasoning lies the concept of similarity. The process of understanding natural language and objects requires reasoning from a relational perspective that can be challenging. Structures, including static structures and dynamic structures, dictate a determined output or action for a given determinate input. More specifically, the determined output or action is based on an express or inherent relationship within the structure. This arrangement may be satisfactory for select circumstances and conditions. However, it is understood that dynamic structures are inherently subject to change, and the output or action may be subject to change accordingly. Existing solutions for efficiently identifying objects and understanding natural language and processing content response to the identification and understanding as well as changes to the structures are extremely difficult at a practical level.

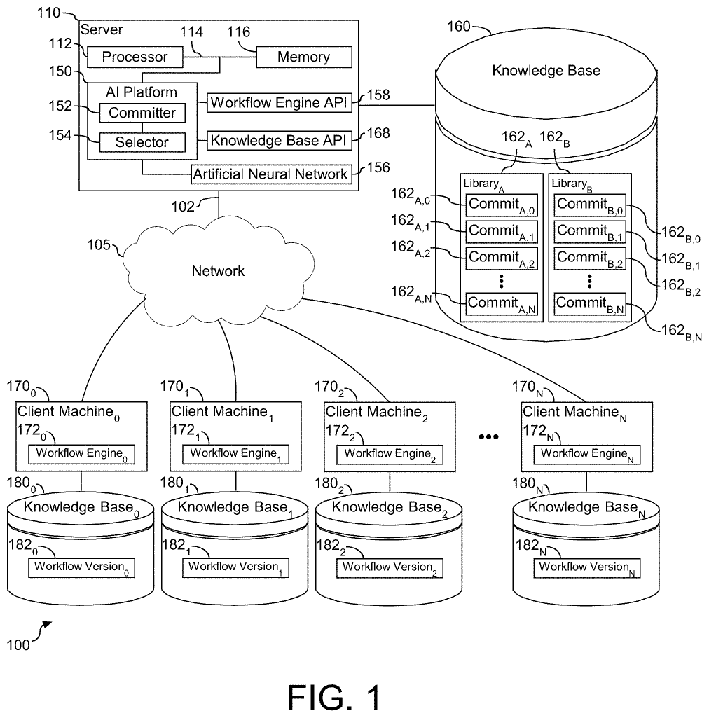

Referring to FIG. 1, a schematic diagram of a computer system (100) is provided with tools for managing workflow version control of two or more heterogeneous workflow engines. As shown, a server (110) is provided in communication with a plurality of instances where a workflow engine is deployed, shown herein by way of example with client machines (170₀), (170₁), (170₂), and (170_{N}) across a network connection (105). The server (110) is configured with a processor (112) in communication with memory (116) across a bus (114). The server (110) is shown with an artificial intelligence (AI) platform (150) operatively coupled to the processor (112), with the AI platform (150) configured to support managing workflow version control. As shown, the AI platform (150) is configured with tools, shown and described herein as a committer (152) and a selector (154). Although only two tools are shown and described, the quantity of tools and their associated titles should not be considered limiting. The client machines (170₀), (170₁), (170₂), and (170_{N}) communicate with each other and with other devices or components via one or more wired and/or wireless data communication links, where each communication link may comprise one or more of wires, routers, switches, transmitters, receivers, or the like. Other embodiments of the server (110) may be used with components, systems, sub-systems, and/or devices other than those that are depicted herein.

The AI platform (150) is configured to receive input (102) from various sources, such as one or more of the client machines, across the network connection (105). For example, the AI platform (150) may receive input from the network (105) or from an operatively coupled knowledge base (160). As shown herein, the knowledge base (160) is populated with one or more libraries, shown herein as library_{A} (162_{A}) and library_{B} (162_{B}), with each library populated with one or more commits. By way of example, library_{A} (162_{A}) is shown populated with commits (162_{A,0}), (162_{A,1}), (162_{A,2}), and (162_{A,N}). Similarly, library_{B} (162_{B}) is shown populated with commits (162_{B,0}), (162_{B,1}), (162_{B,2}), and (162_{B,N}). The quantity of libraries and corresponding commits populated therein are for illustrative purposes and should not be considered limiting. In one embodiment, each library is associated with a specific workflow engine local to one of the client machines (170₀), (170₁), (170₂), and (170_{N}) on the network (105).

Each client machine operatively coupled to the server (110) is provided with or includes a local workflow engine and an operatively coupled local knowledge base. As shown by way of example, client machine₀ (170₀) is shown with workflow engine₀ (172₀) and operatively coupled local knowledge base₀ (180₀), client machine₁ (170₁) is shown with workflow engine₁ (172₁) and operatively coupled local knowledge base₁ (180₁), client machine₂ (170₂) is shown with workflow engine₂ (172₂) and operatively coupled local knowledge base₂ (180₂), and client machine_{N} (170_{N}) is shown with workflow engine_{N} (172_{N}) and operatively coupled local knowledge base_{N} (180_{N}).

The AI platform (150) tools, shown herein as the committer (152) and the selector (154), provide support to manage workflow version control of two or more heterogeneous workflow engines, also referred to herein as local workflow engines (172₀), (1720, (172₂), and (172_{N}). A local workflow version supported by the local workflow engine may be stored in a respective local knowledge base. As shown herein by way of example, local knowledge base₀ (180₀) is shown with local workflow version₀ (182₀), local knowledge base₁ (180₁) is shown with local workflow version₁ (1820, local knowledge base₂ (180₂) is shown with local workflow version₂ (182₂), and local knowledge base_{N} (180_{N}) is shown with local workflow version_{N} (182_{N}). Each stored local workflow version is referred to herein as a commit and is a declarative representation of an instance of a business process corresponding to the operatively coupled workflow engine.

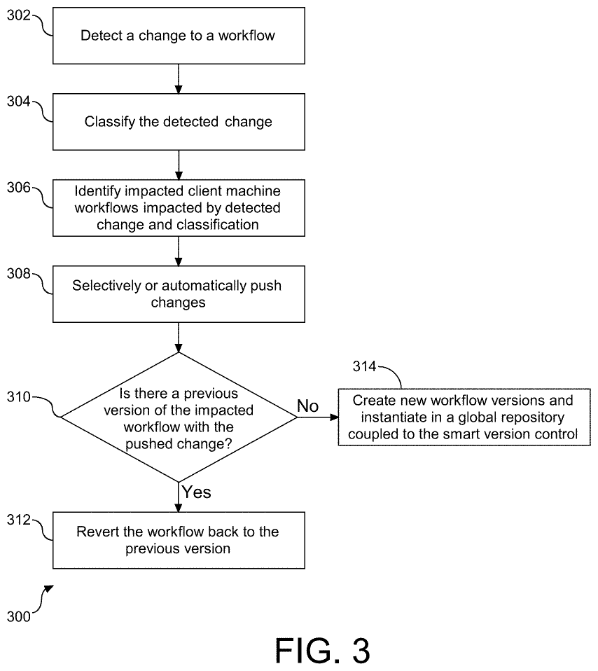

The tools (152) and (154) are operatively coupled, directly or indirectly, and provide the functions, as described below. The committer (152) functions to detect changes in one or more of the local workflows persisted in one or more instances where a workflow engine is deployed to the AI platform (150) across the network (105). The network (105) facilitates sharing and collaboration of the workflows between the one or more workflow engine instances and the server (110) by monitoring workflows pushed by the client machines to the server. The AI platform (150) leverages the tools (152) and (154) to detect changes within the pushed workflows. Sharing changed workflows empowers the design process by the community of workflow users. Tested and improved workflow processes can be pulled by workflow users reducing duplication of efforts of the workflow users having to test and improve the workflow processes themselves. The committer (152) monitors the local workflows communicated across the network (105) and functions to detect changes in the communicated workflow(s). As further discussed in FIG. 3, the committer (152) performs natural language processing (NLP), with respect to detecting a change in one or more of the communicated local workflows. For example, in an embodiment, the NLP monitors and detects a code change made to a workflow from at least one of the client machines (170₀), (170₁), (170₂), or (170_{N}).

As shown, two application program interfaces (APIs), referred to herein as a workflow engine API (158), also referred to herein as a first API, and a knowledge base API (168), also referred to herein as a second API, are operatively coupled to the committer (152) and the selector (154) via the AI platform (150). The second API (168) interfaces with the knowledge base (160) to store and manage storage of a workflow and its association with one or more corresponding client machines, (170₀), (170₁), (170₂), or (170_{N}), as an instantiated commit in the knowledge base (160). The committer (152) detects one or more changes communicated in one or more local workflows, instantiates the detected one or more changes as a workflow commit, and leverages the second API (168) to store the instantiated workflow commit in a corresponding library of the knowledge base (160) along with the instantiated workflow commit representing the original workflow. As shown by way of example, commit (162_{B,0}) may represent an initial workflow commit and commit (162_{B,1}) may represent an instantiation of a modification of the initial workflow commit. In an embodiment, the instantiated workflow commits are stored in a uniform language platform which can be communicated between all of the client machines. Accordingly, the committer (152) monitors workflows across the network (105) to identify and instantiate workflow changes.

As shown herein, an artificial neural network (ANN) (156) is operatively coupled to the AI platform (150). The ANN (156) receives input data in the form of identified or detected workflow changes, and generates output data measuring and classifying an impact of the workflow changes to other workflows operatively coupled to the server (110), as is further discussed in FIG. 3. Upon a detection of a change by the committer (152), the selector (154) employs the ANN (156) to assess which local workflows operatively coupled to the server (110) via the network connection (105) are impacted by the detected change. The selector (154) further employs the ANN (156) to measure the impact of the detected change on the impacted workflows. Based on the measured impact, the selector (154) leverages the second API (168) to select an appropriate commit (162₀), (162₁), (162₂), and (162_{N}) from knowledge base (160) to minimize the measured impact and leverages the operatively coupled committer (152) to push the selected commit to the corresponding client machine (1700, (170₁), (170₂), and (170_{N}), e.g. workflow instance(s). In addition to already being stored in the knowledge base (160), the pushed commit may also be stored in the corresponding local knowledge base (180₀), (1800, (180₂), and (180_{N}) of the associated client machine (170₀), (170₁), (170₂), and (170_{N}) as a new local workflow version. Accordingly, the selector (154) identifies one or more impacted workflows and leverages the ANN (156) to measure the impact of the change on the workflow, and leverages the committer (152) to push a corresponding commit with changes to the workflow to the impacted client machine.

In some illustrative embodiments, server (110) may be the IBM Watson® system available from International Business Machines Corporation of Armonk, N.Y., which is augmented with the mechanisms of the illustrative embodiments described hereafter. The committer (152) and the selector (154), hereinafter referred to collectively as AI tools, are shown as being embodied in or integrated within the AI platform (150) of the server (110). In one embodiment, the AI tools may be implemented in a separate computing system (e.g., 190) that is connected across network (105) to the server (110). Wherever embodied, the AI tools function to support managing workflow version control of two or more local workflow engines.

The client machines operatively coupled to the server (110) may embody different types of information handling systems that can utilize the AI platform (150), ranging from small handheld devices, such as a handheld computer/mobile telephone to large mainframe systems. Examples of handheld computers include personal digital assistants (PDAs), personal entertainment devices, such as MP4 players, portable televisions, and compact disc players. Other examples of information handling systems include pen, or tablet computer, laptop, or notebook computer, personal computer system, and server. As shown, the various information handling systems can be networked together using computer network (105). Types of computer network (105) that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores. The nonvolatile data store(s) can be a component that is external to the various information handling systems or can be internal to one of the information handling systems.

The information handling system employed to support the AI platform (150) may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory. In addition, the information handling system may embody the north bridge/south bridge controller architecture, although it will be appreciated that other architectures may also be employed.

An Application Program Interface (API) is understood in the art as a software intermediary between two or more applications. With respect to the artificial intelligence platform (150) shown and described in FIG. 1, the first and second APIs, (158) and (168), respectively, are utilized to support workflow version control and corresponding workflow commits. Each of the APIs may be implemented in one or more languages and interface specifications.

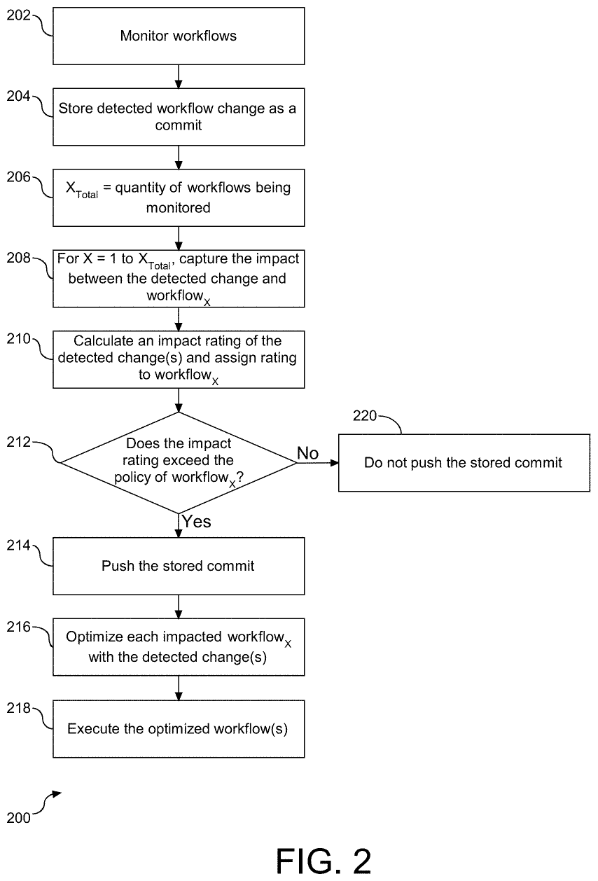

Referring to FIG. 2, a flow chart (200) is provided illustrating a process for managing workflow version control. As shown and described in FIG. 1, two or more client machines are operatively coupled to a server (110) and the AI platform (150). Workflows communicating through the network are monitored or subject to monitoring so that changes to one or more of the workflows may be detected (202). Aspects of the workflow that are monitored for change detection include content code change, e.g. input and output, API change, and workflow structure change, e.g. nested, parent, child, etc. A change in one workflow may affect or otherwise impact another one of the workflows. Similarly, in an embodiment, a change in one workflow may be beneficial to another one of the workflows. A detected workflow change or changes is saved globally in a corresponding library of the knowledge base as an instantiated workflow commit (204). In an exemplary embodiment, the saved instantiated workflow commit is stored in a uniform language platform which can be communicated across any one of the operatively coupled workflow engines. In addition to the storage of the instantiated workflow commit, the previous version of the workflow is instantiated and stored in the knowledge base. Accordingly, the knowledge base may store multiple instantiated workflow commits versions for the same workflow engine.

The variable X_{Total} represents a quantity of workflows being monitored and managed in the shared network of client machines (206). For each of the local workflows being managed by a respective local workflow engine or a local client machine, a relationship between the detected change and workflow_{X} is captured, the relationship indicating whether workflow_{X} is impacted by the detected change (208). For example, if the detected change is an API, and workflow_{X} is associated with the API, then workflow_{X} will have a relationship with the detected change. In an exemplary embodiment, natural language processing is employed to identify workflows that are or may be impacted by the detected change. The relationship between the workflow and the detected change is indicative that the workflow is or may be impacted the detected change. The ANN (156) is employed to identify an impact of the detected change(s) on workflow_{X}, and a rating corresponding to the identified impact is assigned to or associated with the workflow, e.g. workflow_{X}, (210). It is understood in the art that the detected change may be significant, or in an embodiment non-significant, and that the rating corresponds to the impact indicating how much workflow_{X} will be affected by the detected change. In an exemplary embodiment, the higher the rating of the impact, the more workflow_{X} will be affected by the detected change. Accordingly, the ANN assesses an impact of a workflow change on one workflow each of the operatively coupled workflows.

Each workflow can have a rating policy that dictates whether or not to act on the detected change based on the impact assessment. Following step (210), the assessed rating is compared to the rating policy of each of the workflows being monitored and managed, and a determination is made whether the impact exceeds the policy (212). For each of the monitoring and managed workflows in which it is determined at step (212) that the change associated with workflow_{X} is insignificant, e.g. does not at least meet the policy, the identified workflow change is not applied (220), e.g. pushed, and for each of the monitored and managed workflows in which is it determined at step (212) that the change associated with workflow_{X} is significant, e.g. meets or exceeds the policy, the identified workflow change is applied, e.g. pushed, with an instantiation of the push stored in the corresponding library of the knowledge base (214). Accordingly, in response to detection and assessment of a workflow change, the workflows subject to monitoring and management are selectively modified, with a reflection of the modification instantiated locally and globally.

Following step (214) and the selective application of the workflow change(s), the Each workflow_{X} subject to a push to incorporate the workflow change is effectively optimized (216), with the optimization automatically mapping and encoding of the detected changes to the impacted workflow_{X}. In an exemplary embodiment, this optimization occurs automatically in response to the impact rating meeting or exceeding the rating policy of the workflow(s). Following step (216) and the selective optimization of the workflow(s), the workflow engine(s) execute the workflow(s) with the optimization reflected in the current workflow instantiation (218). Accordingly, responsive to the rating policy of the workflow, the workflow engine corresponding to the impacted workflow is optimized with the detected change.

As shown and described, the AI platform (150) effectively functions as a layer or translation interface of smart version control on various workflow engines. In an exemplary embodiment, the detection, evaluation, and selective application of workflow changes are automated to enable sharing and collaboration among users. Similarly, in an embodiment, the detection, evaluation, and selective application of the workflow changes may be customized. Leveraging the uniform language platform enables heterogeneous workflow engines to abstract their corresponding functionality so that different source code languages may be applied to the same or different workflows to facilitate sharing and collaboration of workflow and workflow changes.

Referring to FIG. 3, a flow chart (300) is provided to illustrate an example application of the smart version control. As shown, a change to a workflow is detected (302), and classified (304). The detection at step (302) is directed to workflows and workflow changes. In an exemplary embodiment, the workflow change may include a workflow change that is associated with an API. In this example, the workflow chart is associated with an API and the classification is determined to be critical, and as such the changes need to be selectively propagated with the other workflows. An analysis is conducted to assess or identify which client machine workflows are impacted by the workflow change and the associated API change and classification (306). Natural language processing is employed to identify workflows that contain the API which has experienced the change. Any client machines that process a workflow containing the changed API, are identified as being impacted by the API change. In this example, it is determined that for client_{A} two steps in their workflow, e.g. workflow_{A}, evoke the changed API, and that for client_{B} one step in their workflow, e.g. workflow_{B}, evokes the changed API. Change recommendations are pushed to both client_{A} and client_{B}. The pushed changes can be selectively or automatically applied, depending on one or more settings (308). For example, in an embodiment, the pushed changes may be automatically applied based on a policy setting. Similarly, in an embodiment, the pushed changes may be subject to user approval.

Following step (308), a determination is made whether any previous version of the impacted workflow is saved containing the pushed changes (310). In an exemplary embodiment, the knowledge base (160) is searched for a commit representing a previous version of the impacted workflow, i.e. commit_{A,0} (162_{A,0}). In response to a positive determination at step (310), the impacted workflow is reverted back to the previous version that already contains the pushed change (312). Reverting back to the previous version of the workflow promotes efficiency. Resources are saved as a new workflow version does not need to be created when an older workflow version can be utilized instead. Following a negative response to the determination at step (310), new workflow versions are created and instantiated in a global repository operatively coupled to the smart version control (314), e.g. server (110). In an exemplary embodiment, the selector (154) functions to revert the impacted workflow back to a previous state, with the revert including identification of a stored version entity representing the previous state and propagation of settings represented in the identified storage version entity into the impacted workflow. Accordingly, as demonstrated the smart version control provides a platform to allow different client engines with different source code language, different tool, and different formats to communicate, and for changes to be pushed and pulled across the platform so that the changes can be selectively shared with the different client engines.

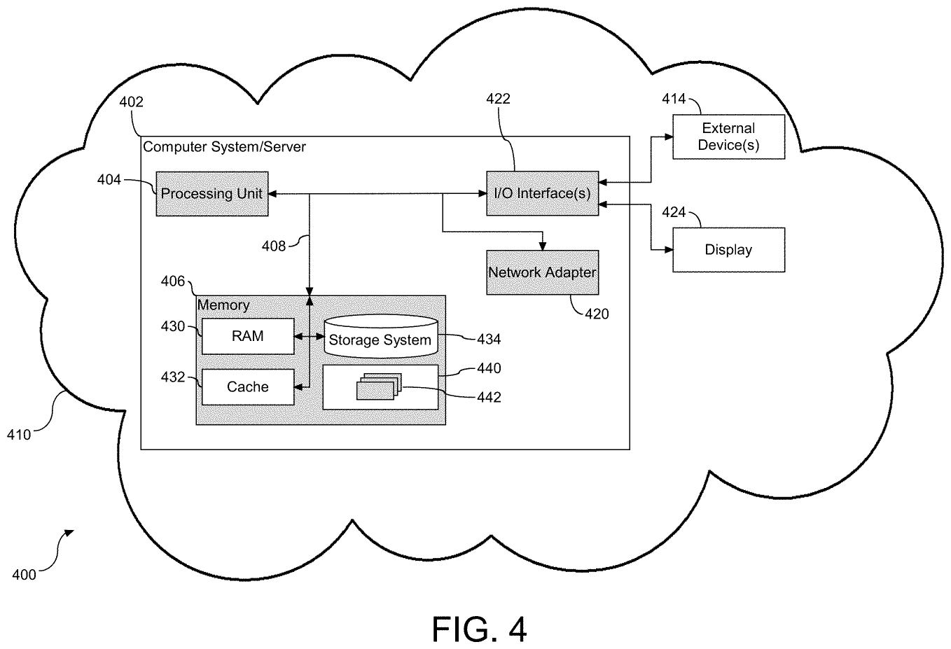

As shown and described in FIGS. 1-3, the management of workflows is effectively simplified by decoupling the consuming and designing of process definitions. Aspects of managing workflow version control of two or more local workflow engines are shown and described with the tools and APIs shown in FIG. 1, and the process shown in FIGS. 2 and 3. Aspects of the functional tools (152) and (154) and their associated functionality may be embodied in a computer system/server in a single location, or in one embodiment, may be configured in a cloud-based system sharing computing resources. With references to FIG. 4, a block diagram (400) is provided illustrating an example of a computer system/server (402), hereinafter referred to as a host (402) in communication with a cloud-based support system, to implement the processes described above with respect to FIGS. 2 and 3. Host (402) is operational with numerous other general purpose or special purpose computing system environments or configurations. Examples of well-known computing systems, environments, and/or configurations that may be suitable for use with host (402) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (402) may be described in the general context of computer system-executable instructions, such as program modules, being executed by a computer system. Generally, program modules may include routines, programs, objects, components, logic, data structures, and so on that perform particular tasks or implement particular abstract data types. Host (402) may be practiced in distributed cloud computing environments (410) where tasks are performed by remote processing devices that are linked through a communications network. In a distributed cloud computing environment, program modules may be located in both local and remote computer system storage media including memory storage devices.

As shown in FIG. 4, host (402) is shown in the form of a general-purpose computing device. The components of host (402) may include, but are not limited to, one or more processors or processing units (404), e.g. hardware processors, a system memory (406), and a bus (408) that couples various system components including system memory (406) to processing unit (404). Bus (408) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (402) typically includes a variety of computer system readable media. Such media may be any available media that is accessible by host (402) and it includes both volatile and non-volatile media, removable and non-removable media.

Memory (406) can include computer system readable media in the form of volatile memory, such as random access memory (RAM) (430) and/or cache memory (432). By way of example only, storage system (434) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (408) by one or more data media interfaces.

Program/utility (440), having a set (at least one) of program modules (442), may be stored in memory (406) by way of example, and not limitation, as well as an operating system, one or more application programs, other program modules, and program data. Each of the operating systems, one or more application programs, other program modules, and program data or some combination thereof, may include an implementation of a networking environment. Program modules (442) generally carry out the functions and/or methodologies of embodiments to support and enable managing workflow version control of two or more local workflow engines. For example, the set of program modules (442) may include the tools (152) and (154) as described in FIG. 1.

Host (402) may also communicate with one or more external devices (414), such as a keyboard, a pointing device, etc.; a display (424); one or more devices that enable a user to interact with host (402); and/or any devices (e.g., network card, modem, etc.) that enable host (402) to communicate with one or more other computing devices. Such communication can occur via Input/Output (I/O) interface(s) (422). Still yet, host (402) can communicate with one or more networks such as a local area network (LAN), a general wide area network (WAN), and/or a public network (e.g., the Internet) via network adapter (420). As depicted, network adapter (420) communicates with the other components of host (402) via bus (408). In one embodiment, a plurality of nodes of a distributed file system (not shown) is in communication with the host (402) via the I/O interface (422) or via the network adapter (420). It should be understood that although not shown, other hardware and/or software components could be used in conjunction with host (402). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (406), including RAM (430), cache (432), and storage system (434), such as a removable storage drive and a hard disk installed in a hard disk drive.

Computer programs (also called computer control logic) are stored in memory (406). Computer programs may also be received via a communication interface, such as network adapter (420). Such computer programs, when run, enable the computer system to perform the features of the present embodiments as discussed herein. In particular, the computer programs, when run, enable the processing unit (404) to perform the features of the computer system. Accordingly, such computer programs represent controllers of the computer system.

In one embodiment, host (402) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

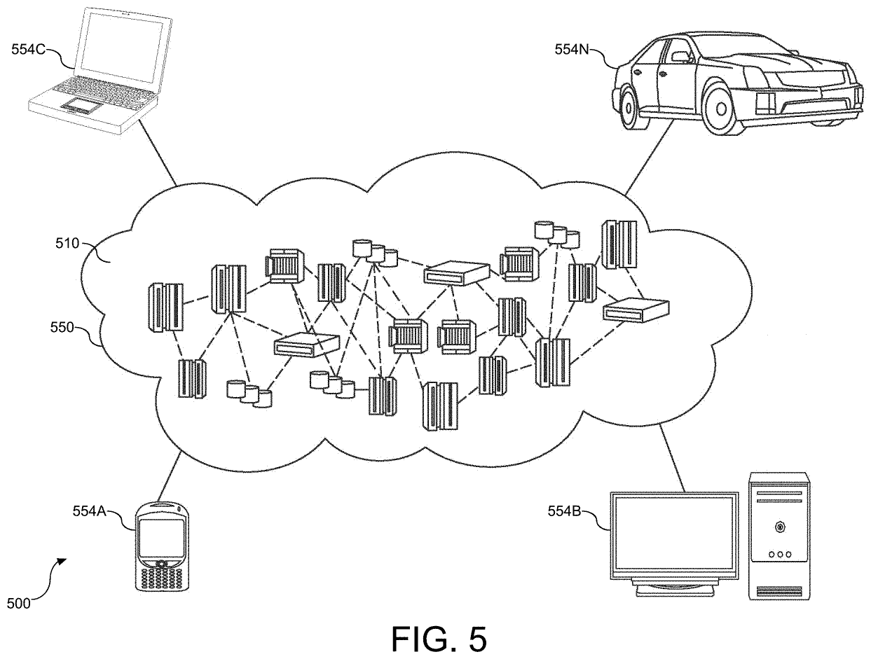

Referring now to FIG. 5, an illustrative cloud computing network (500). As shown, cloud computing network (500) includes a cloud computing environment (550) having one or more cloud computing nodes (510) with which local computing devices used by cloud consumers may communicate. Examples of these local computing devices include, but are not limited to, personal digital assistant (PDA) or cellular telephone (554A), desktop computer (554B), laptop computer (554C), and/or automobile computer system (554N). Individual nodes within nodes (510) may further communicate with one another. They may be grouped (not shown) physically or virtually, in one or more networks, such as Private, Community, Public, or Hybrid clouds as described hereinabove, or a combination thereof. This allows cloud computing environment (500) to offer infrastructure, platforms and/or software as services for which a cloud consumer does not need to maintain resources on a local computing device. It is understood that the types of computing devices (554A-N) shown in FIG. 5 are intended to be illustrative only and that the cloud computing environment (550) can communicate with any type of computerized device over any type of network and/or network addressable connection (e.g., using a web browser).

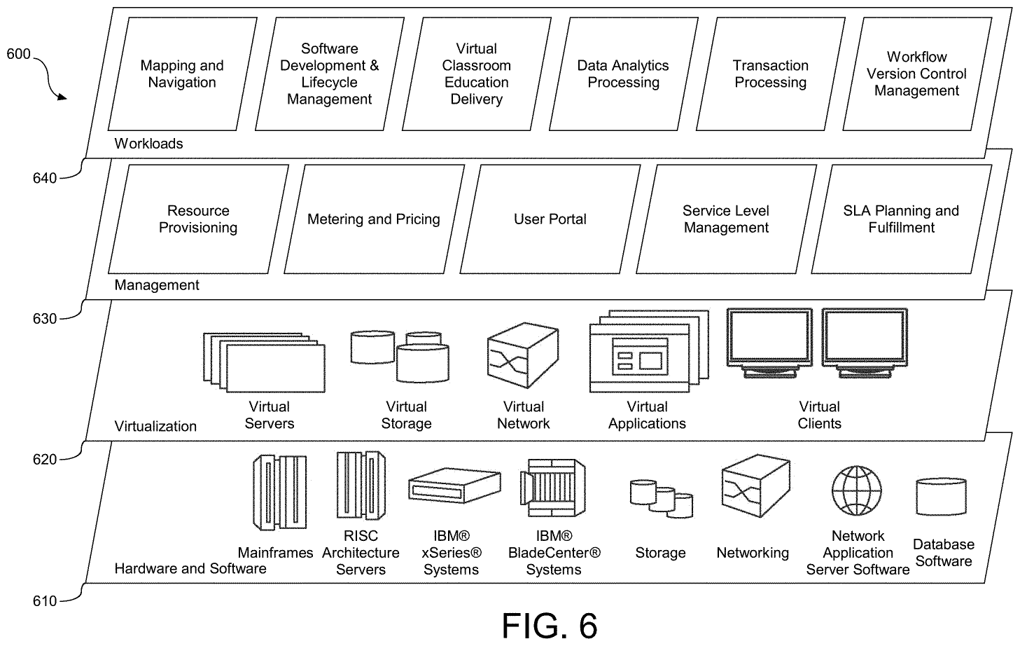

Referring now to FIG. 6, a set of functional abstraction layers (600) provided by the cloud computing network of FIG. 5 is shown. It should be understood in advance that the components, layers, and functions shown in FIG. 6 are intended to be illustrative only, and the embodiments are not limited thereto. As depicted, the following layers and corresponding functions are provided: hardware and software layer (610), virtualization layer (620), management layer (630), and workload layer (640).

The hardware and software layer (610) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (620) provides an abstraction layer from which the following examples of virtual entities may be provided: virtual servers; virtual storage; virtual networks, including virtual private networks; virtual applications and operating systems; and virtual clients.

In one example, management layer (630) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (640) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and workflow version control management.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product are operative to improve the functionality and operation of an AI platform to manage workflow version process control of two or more heterogeneous workflow engines.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. In particular, natural language processing may be carried out by different computing platforms or across multiple devices. Furthermore, the data storage and/or corpus may be localized, remote, or spread across multiple systems. Accordingly, the scope of protection of the embodiments is limited only by the following claims and their equivalents.

What is claimed is:

1. A computer system comprising:
a processing unit operatively coupled to memory;
an artificial intelligence (AI) platform operatively coupled to the processing unit, the AI platform configured with one or more tools to support workflow version process control of two or more heterogeneous workflow engines, the one or more tools comprising:
a committer to monitor one or more workflows corresponding to one or more workflow engines;
a selector to capture a relationship associated with a detected change of the one or more monitored workflows, including:
identify an impact of the detected change to one or more additional workflows; and
assess the identified impact of the detected change on the one or more additional workflows;
the selector to selectively optimize the one or more workflow engines responsive to the assessment, the optimization including automatically mapping and encoding changes corresponding to the impacted one or more additional workflows; and
the processing unit to execute the one or more workflows containing the encoded changes.

2. The computer system of claim 1, wherein the monitor of the one or more workflows further comprises the committer to leverage natural language processing (NLP) to detect the change, the change including: an added or removed argument, modification of an existing argument, an application program interface (API), and combinations thereof.

3. The computer system of claim 1, further comprising the selector to initiate the selective automatic optimization of the one or more workflow engines in response to a corresponding impact assessment.

4. The computer system of claim 1, further comprising the committer to store the detected workflow change as a version entity in an operatively coupled knowledge base, the version entity storing the detected change and an updated version of each workflow modified with the detected change.

5. The computer system of claim 4, wherein the optimization comprises the selector to automatically revert the impacted workflow back to a previous state, the revert including identification of a stored version entity representing the previous state and propagation of settings represented in the identified stored version entity to the impacted workflow.

6. The computer system of claim 4, wherein the version entity is stored in the operatively coupled knowledge base as an instantiation of the workflow in a uniform language platform compatible with each of the one or more workflow engines.

7. A computer program product to support workflow version process control of two or more heterogeneous workflow engines, the computer program product comprising a computer readable storage medium having program code embodied therewith, the program code executable by a processor to:
monitor one or more workflows corresponding to one or more workflow engines;
capture a relationship associated with a detected change of the one or more monitored workflows, including:
identify an impact of the detected change to one or more additional workflows; and
assess the identified impact of the detected change on the one or more additional workflows;
selectively optimize the one or more workflow engines responsive to the assessment, the optimization including automatically mapping and encoding changes corresponding to the impacted one or more additional workflows; and
execute the one or more workflows containing the encoded changes.

8. The computer program product of claim 7, wherein the monitor of the one or more workflows further comprises program code to leverage natural language processing (NLP) to detect the change, the change including: an added or removed argument, modification of an existing argument, an application program interface (API), and combinations thereof.

9. The computer program product of claim 7, further comprising program code to initiate the selective automatic optimization of the one or more workflow engines in response to a corresponding impact assessment.

10. The computer program product of claim 7, further comprising program code to store the detected workflow change as a version entity in an operatively coupled knowledge base, the version entity storing the detected change and an updated version of each workflow modified with the detected change.

11. The computer program product of claim 10, wherein the optimization comprises program code to automatically revert the impacted workflow back to a previous state, the revert including identification of a stored version entity representing the previous state and propagation of settings represented in the identified stored version entity to the impacted workflow.

12. The computer program product of claim 10, wherein the version entity is stored in the operatively coupled knowledge base as an instantiation of the workflow in a uniform language platform compatible with each of the one or more workflow engines.

13. A computer implemented method for workflow version control of two or more heterogeneous workflow engines, comprising:
monitoring one or more workflows corresponding to one or more workflow engines;
capturing a relationship associated with a detected change of the one or more monitored workflows, including:
identifying an impact of the detected change to one or more additional workflows; and
assessing the identified impact of the detected change on the one or more additional workflows;
selectively optimizing the one or more workflow engines responsive to the assessment, the optimization including automatically mapping and encoding changes corresponding to the impacted one or more additional workflows; and
executing the one or more workflows containing the encoded changes.

14. The method of claim 13, wherein the monitoring of the one or more workflows further comprises leveraging natural language processing (NLP) to detect the change, the change including: an added or removed argument, modification of an existing argument, an application program interface (API), and combinations thereof.

15. The method of claim 13, further comprising initiating the selective automatic optimization of the one or more workflow engines in response to a corresponding impact assessment.

16. The method of claim 13, further comprising storing the detected workflow change as a version entity in an operatively coupled knowledge base, the version entity storing the detected change and an updated version of each workflow modified with the detected change.

17. The method of claim 16, wherein the optimization comprises automatically reverting the impacted workflow back to a previous state, the reverting including identifying a stored version entity representing the previous state and propagating settings represented in the identified stored version entity to the impacted workflow.

18. The method of claim 16, wherein the version entity is stored in the operatively coupled knowledge base as an instantiation of the workflow in a uniform language platform compatible with each of the one or more workflow engines.
